(19) United States
(12) Patent Application Publication
(10) Pub. No.: US 2006/0100900 A1
(43) Pub. Date: May 11, 2006

(54) HEALTHCARE CONTENT DELIVERY METHOD

(76) Inventor: Prem Lobo, Biloxi, MS (US)

Correspondence Address: NEIL J. COIG, 2355 DRUSILLA LANE, BATON ROUGE, LA, 70809, US

(21) Appl. No.: 10/904,265

(22) Filed: Nov. 1, 2004

(51) Int. Cl. G06Q 10/00

(52) U.S. Cl. 705/2

(57) ABSTRACT

According to the present invention, a healthcare content delivery method is provided. The healthcare content delivery system provides in-depth information and detail on medical conditions, pre- and post-operative procedures and more, all from a healthcare professional's own office or web presence.

### BACKGROUND OF THE INVENTION

The present invention relates to the delivery of healthcare and medical information, and providing various types of instruction and care information to patients/consumers, vendors and other interested parties.

When a healthcare patient visits a physician or other healthcare professional, they often have many questions surrounding a particular malady or symptom they have been experiencing or are otherwise concerned with. They might also have questions regarding if and how that problem might be rectified through medical treatment. Though a doctor can often answer many of these questions during his time with the patient, almost invariably, the patient forgets a question or worse yet, forgets the information they have just been provided.

This is not surprising, given the fact that nervousness, anxiety and discomfort often accompany a visit to the doctor for a health problem—not the most conducive environment for retaining important medical information and/or instruction. Further, the doctor has limited time to outline and explain the intricate details of a condition, and/or its solution. Thus, there exists a need for additional, more permanent information to be given to the patient/consumer.

Traditionally, medical and healthcare information has been distributed in a one-dimensional fashion, such as by flyer, pamphlet, book or the like. This information, while certainly beneficial, leaves something to be desired both in presentation as well as content, as it is confined in space and effectiveness, leaving the end user, typically the patient, less than ideally informed about a given subject. This lack of education on medical and healthcare issues can lead to increased patient anxiety, inability to properly prepare for a procedure or condition, poor post-operative care and much more. With doctor workload increasing exponentially and the cost of healthcare soaring, there is a long-felt need for expanded patient education at a lower price point.

The present invention proposes a viable solution to this problem. With the advent of the internet and inexpensive portable media, the increased usage of technology both in the home and in the office, and an expanded use of multimedia, this information need not be so one-dimensional or scarce. Information outlining a medical condition, a corrective procedure, post-operative care and more can be presented in great detail using multimedia presentations such as movies, animations, diagrams, charts and more. In order to maintain a “bedside manner” feeling with patients, this information can be distributed through a Doctor's personalized web site or other distribution channel, such as CD-ROM, DVD or workstations in a doctor's office.

### OBJECTS OF THE INVENTION

One object of the invention is to provide a system to deliver healthcare content to supply information to patients and healthcare workers.

Another object of this invention is to provide a more cost-efficient method of providing a healthcare content delivery system.

Yet another object of this invention is to maintain a personal touch associated with a doctor's practice within a healthcare content delivery system.

Still another object of this invention is to provide a more expansive healthcare content delivery system.

Still another object of the invention is to provide a content system that can be updated instantaneously across several sites simultaneously.

Other objects and advantages of this invention shall become apparent from the ensuing descriptions of the invention.

### SUMMARY OF THE INVENTION

According to the present invention, a healthcare content delivery method is provided. Such system provides in-depth information and detail on medical conditions, pre- and post-operative procedures and more, all from a healthcare professional's own office or web presence.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 is an organizational chart of an exemplary embodiment of the healthcare content delivery system.

FIG. 2 is a diagram of the components of the healthcare content delivery system.

### DETAILED DESCRIPTION OF EXEMPLARY EMBODIMENTS

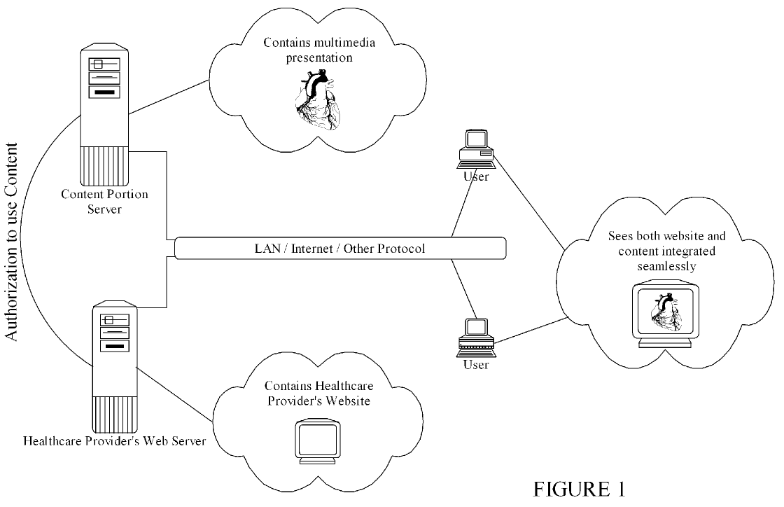

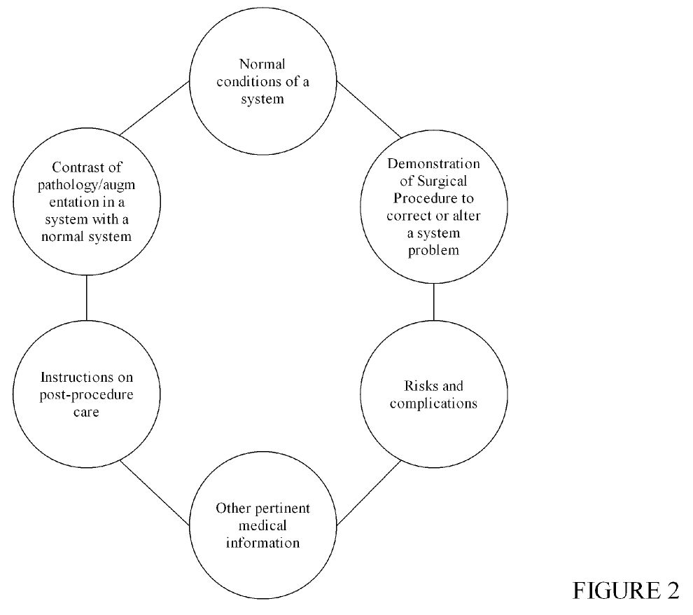

Without any intent to limit the scope of this invention, reference is made to the figures in describing the various embodiments of the invention. FIGS. 1-2 show various aspects of exemplary embodiments of the present invention.

The present invention presents a method for providing healthcare and medical information via multimedia content supplied through various mediums, such as CD-ROMs, DVDs, networks, wi-fi, the internet, or any other vehicle used now for distributing content. The overall purpose behind this medical information is to provide patients and/or consumers with myriad types of information, which can be separated into several content portions, such as:

Information about normal conditions and characteristics of an anatomic system;

Demonstration and comparison of the pathology in an affected system compared to a normal system, or, if elective surgery, a comparison of the current system to a proposed revision of the same system;

A demonstration of the corrective surgical procedure with animated sequences and/or video, which can be superimposed with text and graphics;

Instructions on patient care in the post-operative phase;

Information regarding the risks and potential complications of a given procedure;

All complemented by voice narration and/or music, or other aesthetic cues to enhance the learning experience.

Having this information available to patients/consumers is obviously beneficial from an educational standpoint, but it also helps to allay fears which may derive from a patients' lack of understanding. Further, because of the extensive nature of the information provided, informed consent can be signed based on the presentation of this information. Having this information in place as part of patient education can serve to reduce incidence of complications, in turn, reducing liability and resultant exposure. As such, this serves a type of risk-management tool, as well as an educational measure.

Another aspect of the current invention is that the content can be provided by a centralized center to a doctor's or practice's web site if distributed by network, or branded under a doctor's or healthcare professional's name/practice name if distributed in a fixed media such as CD or DVD. This gives the illusion to the patient/consumer of the content being derived from that doctor or that practice's web site, which is beneficial because it creates a very real sense of continuity in the doctor/patient relationship by providing that critical healthcare information as though from the doctor, rather than from an unknown third party.

In addition to continuity, this also enables the content to be updated across all subscribing distribution points (such as websites, workstations and the like) simultaneously, which is especially beneficial in the medical field, where both the practice and the problems are dynamic in nature and require frequent updates. In this way, the content delivered need only be changed in one location for all subscribing distribution points, further reducing time investment and other expenses. Similarly, in the case of the fixed media model, only a single change is required on a master source of data (such as a master DVD or CD) for all subscribers.

The method herein involves production of content by medical specialists, such as doctors, nurses, licensed practitioners and the like, not just standard personnel. This enhances the quality and accuracy of the content presented. The information is also supplemented with consumer and/or patient feedback, which is then incorporated into the presentations, helping to ensure that patients/consumers will properly understand and comprehend the content provided.

As part of the method, internet storefronts, physician websites, practice websites and the like can be organized for a healthcare professional as well. In this way, the healthcare professional need only provide compensation to a content provider to engineer both the content and delivery of content to patients/consumers.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A method for delivering healthcare content having at least five content portions comprising the steps of:
authoring a first content portion comprising information regarding normal physical and physiological conditions and characteristics of an anatomic system;
authoring a second content portion comprising at least one demonstration and comparison of the pathology in an affected anatomic system as compared to a normal anatomic system;
authoring a third content portion comprising a video demonstration of a surgical procedure to correct said pathology;
authoring a fourth content portion comprising instructions on post-operative patient care;
authoring a fifth content portion comprising information regarding the risks and potential complications of said surgical procedure;
making said content portions independently available across a distribution network so that they may be implemented across multiple distribution points.

2. The method of delivering healthcare content of claim 1 wherein said content portions are authored by healthcare professionals.

3. The method of delivering healthcare content of claim 1 wherein said distribution network is a LAN.

4. The method of delivering healthcare content of claim 1 wherein said distribution network is the internet.

5. The method of delivering healthcare content of claim 1 wherein said distribution network is a subscription for fixed media.

6. The method of delivering healthcare content of claim 1 wherein said video is an animation sequence.

7. A method for delivering healthcare content having at least one content portion comprising the steps of:
authoring said content portion;
making said content portions independently available across a distribution network so that they may be implemented across multiple distribution points.

8. The method of delivering healthcare content of claim 7 wherein said content portion comprises information regarding normal physical and physiological conditions and characteristics of an anatomic system.

9. The method of delivering healthcare content of claim 7 wherein said content portion comprises at least one demonstration and comparison of the pathology in an affected anatomic system as compared to a normal anatomic system.

10. The method of delivering healthcare content of claim 7 wherein said content portion comprises a video demonstration of a surgical procedure to correct said pathology.

11. The method of delivering healthcare content of claim 8 wherein said video is an animation sequence.

12. The method of delivering healthcare content of claim 7 wherein said content portion comprises instructions on post-operative patient care.

13. The method of delivering healthcare content of claim 7 wherein said content portion comprises information regarding the risks and potential complications of said surgical procedure.

14. A method for delivering healthcare content having at least five content portions comprising the steps of:
authoring a first content portion comprising information regarding normal physical and physiological conditions and characteristics of an anatomic system;
authoring a second content portion comprising at least one demonstration and comparison of the proposed alteration of a anatomic system as compared to a current state of said anatomic system;
authoring a third content portion comprising a video demonstration of a surgical procedure to alter said anatomic system;
authoring a fourth content portion comprising instructions on post-operative patient care;
authoring a fifth content portion comprising information regarding the risks and potential complications of said surgical procedure;
making said content portions independently available across a distribution network so that they may be implemented across multiple distribution points.

15. The method of delivering healthcare content of claim 1 wherein said content portions are authored by healthcare professionals.

16. The method of delivering healthcare content of claim 1 wherein said distribution network is a LAN.

17. The method of delivering healthcare content of claim 1 wherein said distribution network is the internet.

18. The method of delivering healthcare content of claim 1 wherein said distribution network is a subscription for media.

19. The method of delivering healthcare content of claim 1 wherein said video is an animation sequence.

20. A method for delivering healthcare content having at least one content portion comprising the steps of:
authoring said content portion;
making said content portions independently available across a distribution network so that they may be implemented across multiple distribution points.

21. The method of delivering healthcare content of claim 20 wherein said content portion comprises information regarding normal physical and physiological conditions and characteristics of an anatomic system.

22. The method of delivering healthcare content of claim 20 wherein said content portion comprises at least one demonstration and comparison of the proposed alteration of a anatomic system as compared to a current state of the anatomic system.

23. The method of delivering healthcare content of claim 20 wherein said content portion comprises a video demonstration of a surgical procedure to alter said anatomic system.

24. The method of delivering healthcare content of claim 23 wherein said video is an animation sequence.

25. The method of delivering healthcare content of claim 20 wherein said content portion comprises instructions on post-operative patient care.

26. The method of delivering healthcare content of claim 20 wherein said content portion comprises information regarding the risks and potential complications of said surgical procedure.
